(19) United States
(12) Patent Application Publication
(10) Pub. No.: US 2026/0016909 A1
(43) Pub. Date: Jan. 15, 2026

(54) ELECTROMAGNETIC RESONANCE PEN

(71) Applicant: Wacom Co., Ltd., Saitama (JP)

(72) Inventors: Takayuki ARAI, Saitama (JP); Kenichi NINOMIYA, Saitama (JP)

(73) Assignee: Wacom Co., Ltd., Saitama (JP)

(21) Appl. No.: 19/335,868

(22) Filed: Sep. 22, 2025

Related U.S. Application Data
(63) Continuation of application No. PCT/JP2024/010260, filed on Mar. 15, 2024.

(30) Foreign Application Priority Data
Mar. 24, 2023 (JP) 2023-047889

(51) Int. Cl. G06F 3/0354

(52) U.S. Cl. CPC G06F 3/03545

(57) ABSTRACT

An electromagnetic resonance pen includes a housing including an opening portion at one end, a pen pressure detection unit fixed to the housing, a columnar magnetic body around which a coil is wound and which includes a through hole, and a core body including a core rod loosely fitted to the through hole of the columnar magnetic body and configured to transmit force to the pen pressure detection unit. The core body includes a wall portion including an inner wall facing a columnar side surface of the columnar magnetic body along a predetermined length in an axial direction of the housing. The electromagnetic resonance pen uses the columnar magnetic body to form a magnetic field.

### BACKGROUND

### Technical Field

This disclosure relates to an electromagnetic resonance pen that functionally operates as a position indicator for a position detection apparatus of an electromagnetic resonance system.

### Description of the Related Art

When a pencil is used to make a sketch, the pencil may be tilted nearly horizontal to a paper surface, or the like, to paint a wide range and draw a shade, for example. Specifically, the pencil can be tilted at 25 to 30 degrees to a recording medium, and the side surface of the graphite part of the pencil can be used to paint a wide range. In recent years, an electronic pen has increasingly been used to digitally draw (input) a picture on a drawing apparatus, such as a tablet information terminal, for example. Hence, when the electronic pen is used to draw a picture on the drawing apparatus, it would also be desirable for the electronic pen to be capable of painting a wide range similar to that of a pencil.

To reflect the input of the electronic pen on the drawing apparatus, the electronic pen needs to be detected by a position detection apparatus included in the drawing apparatus. The position detection apparatus detects the position of a pen tip of the electronic pen and the value of the pen pressure applied to the pen tip. The pen pressure of the electronic pen is detected when a core body presses the pen pressure detection unit inside of the electronic pen according to the pen pressure. In general, when a writing tool, such as a pencil, is used to write a character on a recording medium, such as paper, the writing tool is tilted at an angle of 60 to 80 degrees to the recording medium to write the character. When the electronic pen is used to input the character to the position detection apparatus in this state, the pressing force of the pen tip is transmitted to the core body, and the pen pressure detection unit is pressed.

However, when the electronic pen is used in such a manner that the writing tool is laid down (tilted) at 25 to 30 degrees to add a shadow to an object drawn on the recording medium, the core body is bent in a direction crossing the axial center of the electronic pen, and the pen pressure is not transmitted to the pen pressure detection unit. In view of this, Japanese Patent No. 7154209 discloses an electronic pen that includes a cylindrical housing including a surface which is formed by a fitting groove or the like and which is facing a surface of an inside or an outside of a recessed portion of a core body, such that a core rod can press a pen pressure detection unit even when the electronic pen is tilted. In this case, the surface formed by the fitting groove or the like provided on the housing faces the surface of the inside or the outside of the recessed portion of the core body. Thus, the core body is not bent in the direction crossing the axial center of the electronic pen, and the pen pressure applied to the pen tip of the core body is appropriately applied to the pen pressure detection unit.

In the case of the electronic pen disclosed in Japanese Patent No. 7154209, the fitting groove or the like is provided on the housing, and processing is executed to form the surface. Hence, the strength of the housing may be reduced depending on how the fitting groove or the like is provided. In addition, a resonant circuit including a coil and a capacitor is mounted in a case of an electronic pen of the electromagnetic resonance system (electromagnetic resonance pen). A problem in obtaining a desirable magnetic field distribution on the position detection apparatus side includes determining how to arrange a magnetic body (ferrite core), around which the coil is wound, with respect to the housing. Further, the desirable magnetic field distribution cannot be obtained unless the positional relation between the magnetic body, around which the coil is wound, and the core body is also appropriately set. In addition, the method of attaching the magnetic body to the housing also needs to be set appropriately depending on the arrangement of the magnetic body (ferrite core) on the housing.

### BRIEF SUMMARY

In view of the above, the present disclosure describes an electromagnetic resonance pen that can obtain an appropriate magnetic field distribution without reducing the strength of a housing and that can input an instruction to a drawing apparatus when the electromagnetic resonance pen is used in such a manner as to be tilted nearly horizontally to paint a wide range.

To solve the problems noted above, the present disclosure provides an embodiment of an electromagnetic resonance pen including a housing including an opening portion at one end, a pen pressure detection unit fixed to the housing, a columnar magnetic body around which a coil is wound and that includes a through hole, and a core body including a core rod loosely fitted to the through hole and configured to transmit force to the pen pressure detection unit and a wall portion including an inner wall facing a columnar side surface of the magnetic body along a predetermined length in an axial direction of the housing, in which the electromagnetic resonance pen uses the magnetic body to form a magnetic field.

Further, to solve the problems noted above, the present disclosure also provides an embodiment of an electromagnetic resonance pen including a housing including an opening portion at one end, a core body including a front end portion and a core rod, a magnetic body which is formed in a columnar shape such that a coil is wound around the magnetic body, which includes a hole through which the core rod passes, and whose front end side is provided at a position exposed from the opening portion in a state in which the core body is removed, and a magnetic body holder that is fixed to the housing and includes a fixing portion which fixes a back end side of the magnetic body to prevent the magnetic body from being pulled out from the opening portion.

### BRIEF DESCRIPTION OF THE SEVERAL VIEWS OF THE DRAWINGS

FIG. 1 is a diagram for describing an example of the appearance of an electromagnetic resonance pen of the disclosed embodiments and an example of the appearance of a tablet information terminal for which the electromagnetic resonance pen is used to input information;

FIGS. 2A and 2B are an external view (FIG. 2A) and a cross-sectional view (FIG. 2B) of a connection part of a core body and a housing of the electromagnetic resonance pen of a first embodiment;

FIGS. 3A and 3B are an external view (FIG. 3A) and a cross-sectional view (FIG. 3B) of a connection part of a core body and a housing of an electromagnetic resonance pen of a second embodiment;

FIGS. 4A and 4B are diagrams for describing the sizes of parts on the pen tip side of the electromagnetic resonance pen of the second embodiment;

FIGS. 5A and 5B are diagrams for describing a configuration example in which a waterproof function is added to the electromagnetic resonance pen of the first embodiment; and

FIGS. 6A and 6B are diagrams for describing a configuration example in which the waterproof function is added to the electromagnetic resonance pen of the second embodiment.

### DETAILED DESCRIPTION

Embodiments of an electromagnetic resonance pen of the present disclosure will be described with reference to the drawings.

### Example of the Appearance of an Electromagnetic Resonance Pen and Example of the Appearance of a Tablet Information Terminal

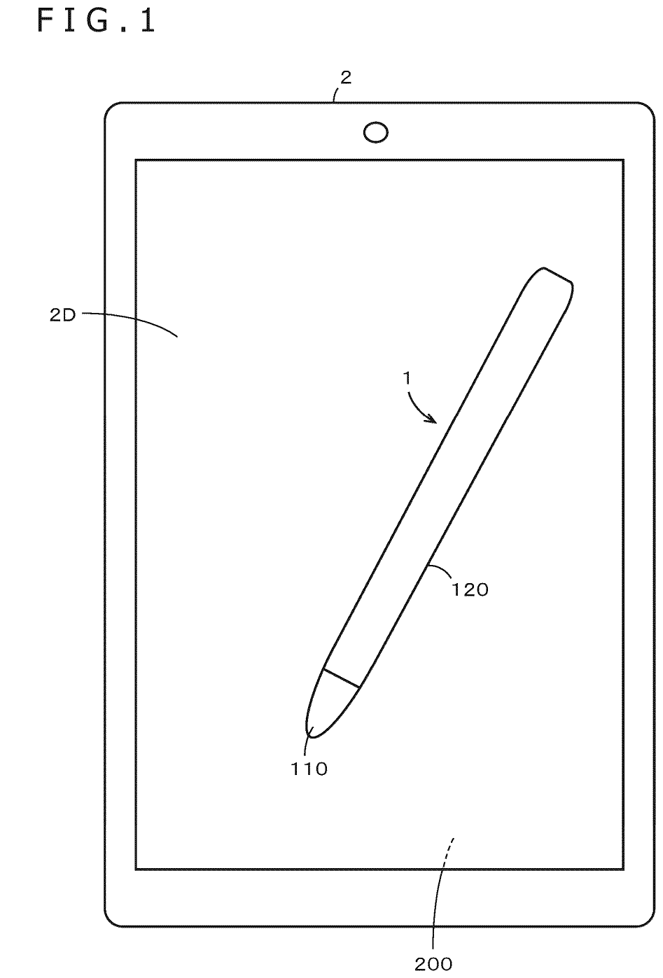

FIG. 1 is a diagram for describing an example of the appearance of an electromagnetic resonance pen 1 of the embodiments and an example of the appearance of a tablet information terminal 2 for which the electromagnetic resonance pen 1 is used to input information. The appearance of the electromagnetic resonance pen 1 includes two major parts including a core body 110 and a housing 120. The core body 110 is a part corresponding to a pen tip of a fountain pen or the like. The housing 120 is a part held by a hand of a user. The electromagnetic resonance pen 1 functions as a pen-type position indicator (coordinate indicator) used to input information to the tablet information terminal 2.

Meanwhile, a relatively large display screen 2D of a display device, such as a liquid crystal display (LCD), is exposed in the tablet information terminal 2. The display screen 2D has, on its back, a position detection apparatus (input device) 200 that includes a sensor unit of the electromagnetic resonance system corresponding to the entire surface of the display screen 2D such that the indicated position can be detected regardless of the position indicated on the display screen 2D. Note that the sensor unit of the position detection apparatus 200 is provided on the back (back surface) of the display screen 2D in some cases and provided on the front (front surface) in other cases. It is assumed that the sensor unit is provided on the back of the display screen 2D in this example. The display device (such as an LCD) and the input device (position detection apparatus 200) are connected to the inside of a housing of the tablet information terminal 2, and an information processing apparatus unit (not illustrated), which executes various types of information processing, is mounted to the inside of the housing of the tablet information terminal 2.

As described above, the tablet information terminal 2 is an information processing apparatus including the position detection apparatus 200 as a main input device. Note that protective glass or the like is provided on the display screen 2D, for example, and the electromagnetic resonance pen 1 can be used to input an instruction on the display screen 2D as an operation surface through the protective glass. It is assumed that the electromagnetic resonance pen 1 is used to perform a position indication operation on the display screen 2D in the tablet information terminal 2. In this case, a processing unit (central processing unit (CPU)) included in the position detection apparatus 200 specifies the position indicated on the display screen 2D based on a detection output from the sensor unit of the position detection apparatus 200 provided on the back of the display screen 2D. Information representing the indicated position specified by the processing unit is supplied to the information processing apparatus unit mounted on the tablet information terminal 2, and a process according to the information can be executed.

As described above, the electromagnetic resonance pen 1 and the position detection apparatus 200 mounted on the tablet information terminal 2 of the embodiments are based on the electromagnetic resonance system. In the electromagnetic resonance system, the position detection apparatus includes the sensor unit including a plurality of loop coils arranged in each of an X-axis direction and a Y-axis direction. A transmission period and a reception period are alternately provided, where the transmission period is for sequentially supplying power to the plurality of loop coils of the sensor unit to generate a magnetic field, and the reception period is for stopping the supply of power to receive a magnetic field from the outside. The corresponding electromagnetic resonance pen includes a resonant circuit including a coil and a capacitor, and a signal is generated when a current flows through the coil according to the magnetic field from the sensor unit. Pen pressure information is included in the signal, and the signal is transmitted to the sensor unit. The position detection apparatus receives the signal through the sensor unit in the reception period and detects the position indicated by the electromagnetic resonance pen and the pen pressure.

### Configuration Example of the Electromagnetic Resonance Pen 1 of the First Embodiment

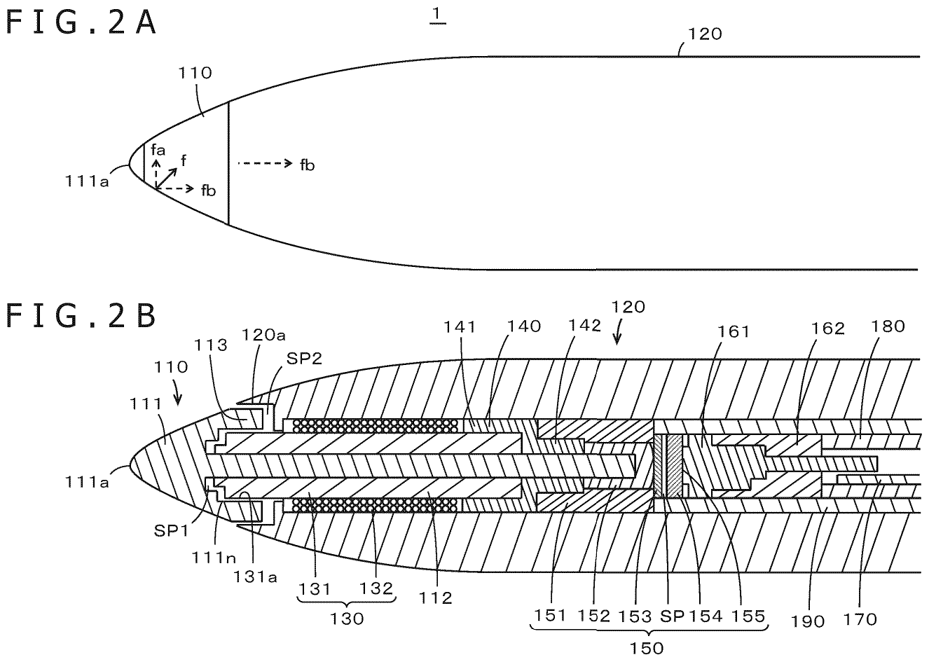

FIGS. 2A and 2B are an external view (FIG. 2A) and a cross-sectional view (FIG. 2B) of a connection part of the core body 110 and the housing 120 of the electromagnetic resonance pen 1 of a first embodiment. As illustrated in the external view of FIG. 2A, the appearance of the electromagnetic resonance pen 1 includes two major parts including the core body 110 and the housing 120. As illustrated in FIG. 2B, the core body 110 includes a front end portion (nib) 111 in a triangular pyramid (conc) shape including a roundish front end 111a and a core rod 112 provided at a position coinciding with a center axis of the front end portion 111, the core rod 112 extending in a direction away from the front end 111a.

The housing 120 includes an opening portion on the pen tip side (left end side of FIG. 2B), and is formed in a cylindrical shape. An electronic pen function unit that realizes the function of the electronic pen is housed inside the housing 120. As illustrated in FIG. 2B, a coil portion 130 is provided on the core body 110 side in the housing 120, and includes a coil 132 formed by winding a coated conductor wire around a side surface of a ferrite core 131 including a through hole, through which the core rod 112 of the core body 110 passes. A part with a predetermined length from the front end toward the back end on the pen tip side of the ferrite core 131 of the coil portion 130 is exposed outside from an opening on the pen tip side (left end side of FIG. 2B) of the housing 120.

A pen pressure detection unit 150 is connected to the back end side of the ferrite core 131 of the coil portion 130 through a core holder 140. The core holder 140 has a two-stage configuration including a holding portion 141 with an inner diameter the same as or slightly shorter than an outer diameter of the ferrite core 131 and a connection portion 142 with an outer diameter shorter than that of the holding portion 141. The connection portion 142 of the core holder 140 is provided with a through hole through which the core rod 112 of the core body 110 passes. In this way, a back end part of the ferrite core 131 is fitted to the holding portion 141, and the core holder 140 holds the ferrite core 131, as illustrated in FIG. 2B. Meanwhile, the connection portion 142 of the core holder 140 is fitted to and held by a part on the front end side of a pen pressure detection unit house 151.

The pen pressure detection unit 150 includes a pressing member 152 that holds a back end part of the core rod 112 of the core body 110 and that is housed in the pen pressure detection unit house 151 in a cylindrical shape, as illustrated in FIG. 2B. The pressing member 152 is formed by an elastic material, such as rubber, and the core rod 112 of the core body 110 can be inserted and removed. When the core rod 112 is inserted, the core rod 112 can be held such that the core rod 112 does not easily come off.

An end portion on the back end side of the pen pressure detection unit house 151 is also an opening which is closed by a conductive rubber 153. As also described later, the conductive rubber 153 functions as one of a variable capacitor's electrodes. A ring-shaped spacer, which is not illustrated, is provided on the side of the conductive rubber 153 opposite the pen pressure detection unit house 151, and a dielectric 154 is provided across the spacer. Hence, a space SP is provided between the conductive rubber 153 and the dielectric 154. Another electrode 155 is provided on a surface of the dielectric 154 on the opposite side of the conductive rubber 153.

In this way, the conductive rubber 153 and the electrode 155 are provided to face each other across the dielectric 154, and this configuration provides a capacitor. The space SP is provided between the conductive rubber 153 and the dielectric 154 as also described above, and the capacitor functions as a variable capacitor in which the capacitance changes according to how close the conductive rubber 153 is to the dielectric 154.

The front end portion 111 of the core body 110 includes a recessed portion recessed from the opposite side (bottom surface side) of the front end 111a toward the front end 111a side. Hence, when the core body 110 is mounted on the housing 120 including the electronic pen function unit, the front end portion of the ferrite core 131 included in the electronic pen function unit is fitted into the recessed portion of the front end portion 111 of the core body 110 as illustrated in FIG. 2B. In this case, the recessed portion formed on the front end portion 111 of the core body 110 includes a wall portion 113 including an inner wall 111n facing a columnar side surface 131a on the pen tip side of the ferrite core 131 along a predetermined length in the axial direction of the housing 120, as illustrated in FIG. 2B.

As illustrated in FIG. 2B, a recessed portion is formed toward the back end side at the opening part on the pen tip side of the housing 120, and the back end side of the front end portion 111 of the core body 110 is fitted into the recessed portion. In this way, the wall portion 113 of the front end portion 111 of the core body 110 is placed between the ferrite core 131 and the housing 120 along a predetermined length in the axial direction of the housing 120 as illustrated in FIG. 2B. That is, the wall portion 113 of the front end portion 111 of the core body 110 is placed between the columnar side surface 131a of the ferrite core 131 and an inner wall surface 120a at the front end part of the housing 120.

In this case, a space SP1 is provided between the recessed portion of the front end portion 111 of the core body 110 and the front end portion on the pen tip side of the ferrite core 131 as illustrated in FIG. 2B. In addition, a space SP2 is provided between the back end surface of the wall portion 113 of the front end portion 111 of the core body 110 and the front end surface in the recessed portion on the pen tip side of the housing 120. As a result, when the pen pressure is applied to the core body 110, the core body 110 is pushed toward the housing 120, and the core rod 112 of the core body 110 pushes the conductive rubber 153 toward the dielectric 154 through the pressing member 152 of the pen pressure detection unit 150. When the pen pressure applied to the core body 110 is released, the core body 110 is pushed back by the elastic force of the conductive rubber 153 and the like. Hence, how close the conductive rubber 153 is to the dielectric 154 varies according to the pen pressure applied to the core body 110, and the capacitance of the pen pressure detection unit 150 changes. The pen pressure applied to the core body 110 can accurately be detected according to the changing capacitance.

The front end surface of an inner housing 190 formed in a cylindrical shape is pressed against the back end surface of the pen pressure detection unit house 151 of the pen pressure detection unit 150, and a board holding member 161 is provided on the electrode 155 side of the pen pressure detection unit 150 such that the electrode 155 is pressed against the dielectric 154 side. The board holding member 161 is held by a cylindrical fixing member 162 in such a manner as not to rattle in the direction crossing the axial center in the inner housing 190. A circuit board 170 is held in the inner housing 190 and placed between the board holding member 161 and the fixing member 162. Various circuit elements, such as an integrated circuit (IC) included in a control unit and a plurality of capacitors, are used to form an electronic circuit on the circuit board 170.

The circuit board 170 is housed in a board protection pipe 180, and an end portion on the core body 110 side of the board protection pipe 180 comes into contact with an end portion of the fixing member 162. An unillustrated lid comes into contact with the end portion on the back end side of the board protection pipe 180 from the back end of the inner housing 190 to close the housing 120. In this way, the positions of the pen pressure detection unit 150, the board holding member 161, the fixing member 162, the circuit board 170, and the board protection pipe 180 are fixed in the inner housing 190. The coil portion 130 and the pen pressure detection unit 150 are connected to each other through the core holder 140. A predetermined lid pushes the inner housing 190 toward the core body 110 from the back end of the housing 120 and restricts the position of the inner housing 190.

Although not illustrated, both ends of the coil 132 provided around the ferrite core 131 are connected to the electronic circuit formed on the circuit board 170. Circuit elements, such as a plurality of capacitors, are used to provide the electronic circuit formed on the circuit board 170 as also described above, and the coil 132 and the capacitors on the circuit board 170 provide a resonant circuit. The conductive rubber 153 and the electrode 155 of the pen pressure detection unit 150 are also connected to the electronic circuit of the circuit board 170 through a conductive line. In this way, the electronic pen function unit, including the coil portion 130, the pen pressure detection unit 150, and the circuit board 170 as main parts, is provided in the housing 120.

Accordingly, the resonant circuit including the coil 132 and the capacitor of the electromagnetic resonance pen 1 receives the signal transmitted from the position detection apparatus 200 of the electromagnetic resonance type of the tablet information terminal 2. The resonant circuit of the electromagnetic resonance pen 1 generates a signal corresponding to the received signal and transmits the signal to the position detection apparatus 200. At this point, the phase of the transmitted signal is adjusted according to the pen pressure detected by the pen pressure detection unit 150, and the position detection apparatus 200 is also notified of the pen pressure applied to the core body 110 of the electromagnetic resonance pen 1.

It is assumed that an instruction is input by bringing down (laying down) the electromagnetic resonance pen 1 and bringing the side surface of the front end portion 111 of the core body 110 into contact with the operation surface on the display screen 2D of the tablet information terminal 2. As described with reference to FIGS. 2A and 2B, the front end portion 111 of the core body 110 has a triangular pyramid shape (tapered shape). Hence, the side surface of the front end portion 111 is tilted, and the pen pressure is applied as indicated by a solid arrow f in FIG. 2A. The pen pressure f includes a component fa in a direction crossing the axial center of the electromagnetic resonance pen 1 and a component fb in a direction along the axial center of the electromagnetic resonance pen 1 as indicated by dotted arrows in FIG. 2A.

Hence, when the pen pressure f is applied to the side surface of the front end portion 111 of the core body 110, the component fb of the pen pressure f is applied to the core rod 112 of the core body 110. This is transmitted to the pen pressure detection unit 150, and the pen pressure can be detected. An instruction can be input to the tablet information terminal 2 if both the indicated position and the pen pressure can be detected. For example, an instruction for bringing a pencil down to draw a shadow can be input to the tablet information terminal 2 with use of the electromagnetic resonance pen 1.

More specifically, the magnetic field generated in the electromagnetic resonance pen 1 reaches the position detection sensor of the tablet information terminal 2. An appropriate magnetic field distribution is formed on the position detection sensor, and the indicated position and the pen pressure can be recognized. Hence, when the electromagnetic resonance pen 1 is put up to write a character, the magnetic field distribution is formed in a narrow range on the position detection sensor, and a line can be drawn and input. When the electromagnetic resonance pen 1 is laid down and used for painting, the magnetic field distribution is formed in a relatively wide range on the position detection sensor, and the painting can be drawn and input. Moreover, a fitting groove or the like for fitting the part of the core body 110 to the housing 120 does not have to be provided in the case of the electromagnetic resonance pen 1 of the first embodiment described with reference to FIGS. 2A and 2B, and the strength of the housing 120 is not reduced.

As described above, the part on the pen tip side of the ferrite core 131 protrudes from the opening portion on the pen tip side of the housing 120. Hence, in a state in which the core body 110 is removed, the part on the pen tip side of the ferrite core 131 is exposed outside, and the user may inconveniently pull out the ferrite core 131. Therefore, it is preferable to attach the back end part of the ferrite core 131 to the inside of the holding portion 141 of the core holder 140 to prevent the ferrite core 131 from easily being removed.

The core holder 140 cannot move toward the pen tip because, for example, the front end surface of the core holder 140 is engaged with a protrusion of an inner wall surface of the housing 120. The core holder 140 is held by the pen pressure detection unit house 151 and the inner housing 190 from the back end side, thus also preventing the core holder 140 from moving toward the back end. That is, the core holder 140 is fixed to the inside of the housing 120, and the ferrite core 131 cannot be easily pulled out. Note that the core holder 140 is formed by a resin material, and the formation is easy to perform. Therefore, the core holder 140 does not electrically affect the other parts.

Note that, as illustrated in FIG. 2B, the end portion on the pen tip side of the recessed portion of the front end portion 111 of the core body 110 and the front end part on the pen tip side of the ferrite core 131 have corresponding step shapes such that they are fitted to each other in the electromagnetic resonance pen 1 of the first embodiment. In this way, the end portion on the pen tip side of the recessed portion of the front end portion 111 of the core body 110 and the front end part on the pen tip side of the ferrite core 131 are fitted to each other when the pen pressure is applied to the core body 110, thus preventing rattling in the direction crossing the axial direction.

### Configuration Example of the Electromagnetic Resonance Pen 3 of the Second Embodiment

The front end portion 111 of the core body 110 is small in the case of the electromagnetic resonance pen 1 of the first embodiment described with reference to FIGS. 2A and 2B, and the usability may become poor when the electromagnetic resonance pen 1 is laid down and used. Hence, a front end portion 311 of a core body 310 in the case of an electromagnetic resonance pen 3 of a second embodiment is larger than the front end portion 111 of the core body 110 of the electromagnetic resonance pen 1 of the first embodiment. Thus, the electromagnetic resonance pen 3 of the second embodiment can also be used as a position indicator of the tablet information terminal 2 as with the case of the electromagnetic resonance pen 1 described with reference to FIG. 1.

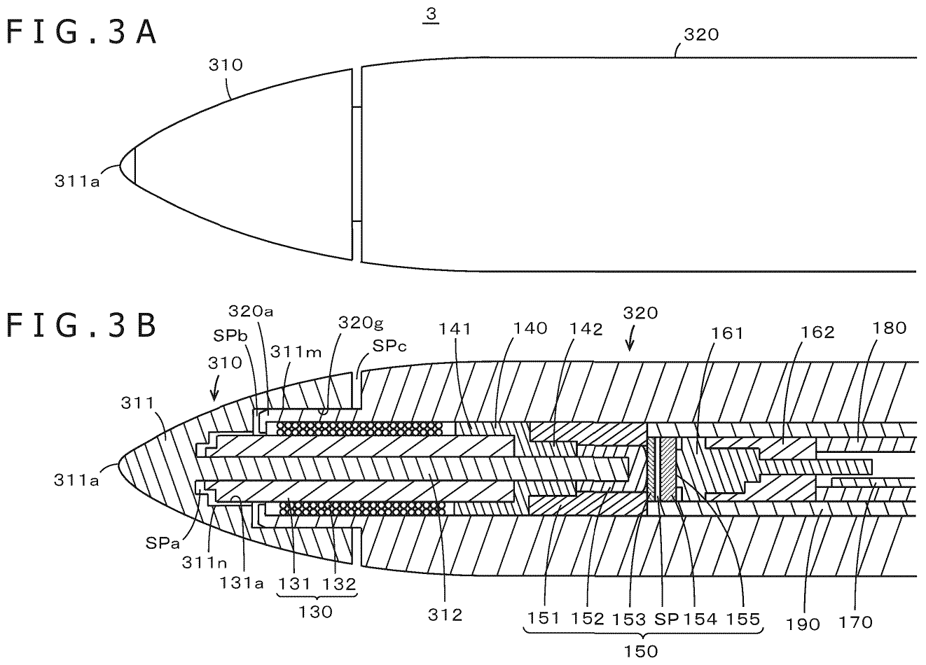

Note that the configurations of the core body 310 and a housing 320 of the electromagnetic resonance pen 3 of the second embodiment described below are different from those of the electromagnetic resonance pen 1 of the first embodiment. However, the other configurations of the electronic pen body portion are substantially similar to those of the electromagnetic resonance pen 1 of the first embodiment. Therefore, the same reference signs are provided to the parts of the electromagnetic resonance pen 3 of the second embodiment illustrated in FIGS. 3A and 3B with similar configurations to those of the electromagnetic resonance pen 1 of the first embodiment, and the parts will not be described in detail.

FIGS. 3A and 3B are an external view (FIG. 3A) and a cross-sectional view (FIG. 3B) of a connection part of the core body 310 and the housing 320 of the electromagnetic resonance pen 3 of the second embodiment. As illustrated in the external view of FIG. 3A, the appearance of the electromagnetic resonance pen 3 includes two major parts including the core body 310 and the housing 320. As illustrated in FIG. 3B, the core body 310 includes the front end portion (nib) 311 in a triangular pyramid (cone) shape including a roundish front end 311a and a core rod 312 provided at a position coinciding with the center axis of the front end portion 311, the core rod 312 extending in a direction away from the front end 311a. As can be understood by comparing FIGS. 3A and 3B and FIGS. 2A and 2B, the front end portion 311 of the core body 310 of the second embodiment is formed largely on the back end side compared to the front end portion 111 of the core body 110 of the first embodiment.

The housing 320 includes an opening portion on the left end side of FIG. 3B, and is formed in a cylindrical shape. The electronic pen function unit that realizes the function of the electronic pen is housed inside the housing 320. As illustrated in FIG. 3B, the outer diameter of the housing 320 is reduced to provide a mount portion 320a on the pen tip side of the housing 320, and the front end portion 311 of the core body 310 is mounted on the mount portion 320a. The end surface on the pen tip side of the mount portion 320a is an opening portion, and a part with a predetermined length from the front end to the back end side of the ferrite core 131 protrudes from the opening portion.

In this way, the ferrite core 131 protrudes largely from the opening portion on the pen tip side of the housing 320 in the electromagnetic resonance pen 3 of the second embodiment. Hence, when the core body 310 is not mounted, there is a possibility that the ferrite core 131 will be pulled out by pinching the front end part with nails or biting the front end part with teeth. Therefore, the side surface of the back end part of the ferrite core 131 and the inner wall surface of the holding portion of the core holder 140 are attached by an adhesive Ad as illustrated in FIG. 3B.

The front end portion 311 of the core body 110 includes a recessed portion recessed from the opposite side (bottom surface side) of the front end 311a toward the front end 311a. Hence, when the core body 310 is mounted on the housing 320 provided with the electronic pen function unit, the front end portion of the ferrite core 131 included in the electronic pen function unit and the mount portion 320a of the housing 320 are fitted into the recessed portion of the front end portion 311 of the core body 310 as illustrated in FIG. 3B. In this case, the recessed portion formed on the front end portion 311 of the core body 310 includes a wall portion including a first inner wall 311n facing the columnar side surface 131a on the pen tip side of the ferrite core 131 along a predetermined length in the axial direction of the housing 120, as illustrated in FIG. 3B. As illustrated in FIG. 3B, a side surface (surface on the outer diameter of the opening portion of the housing 320) 320g of the mount portion 320a of the housing 320 and a second inner wall 311m on the opening side of the front end portion 311 of the core body 310 face each other along a predetermined length in the axial direction of the housing 320.

In this case, a space SPa is provided between the end portion on the pen tip side of the recessed portion of the front end portion 311 of the core body 310 and the front end portion on the pen tip side of the ferrite core 131 as illustrated in FIG. 3B. A space SPb is provided between the end surface of the middle part of the recessed portion of the front end portion 311 of the core body 310 and the end surface on the pen tip side of the mount portion 320a of the housing 320. A space SPc is provided between the back end surface of the front end portion 311 of the core body 310 and the end surface spreading outside the back end part of the mount portion 320a of the housing 320.

As a result, when the pen pressure is applied to the core body 310, the core body 310 is pushed toward the housing 320, and the core rod 312 of the core body 310 pushes the conductive rubber 153 toward the dielectric 154 through the pressing member 152 of the pen pressure detection unit 150. When the pen pressure applied to the core body 310 is released, the core body 310 is pushed back by the elastic force of the conductive rubber 153 and the like. Hence, how close the conductive rubber 153 is to the dielectric 154 varies according to the pen pressure applied to the core body 310, and the capacitance of the pen pressure detection unit 150 changes. The pen pressure applied to the core body 310 can accurately be detected according to the changing capacitance.

In the case of the electromagnetic resonance pen 3 of the second embodiment, the front end portion 311 of the core body 310 is larger than the front end portion 111 of the core body 110 of the electromagnetic resonance pen 1 of the first embodiment described with reference to FIGS. 2A and 2B. Accordingly, when the electromagnetic resonance pen 3 is laid down and used for painting, the magnetic field distribution is formed in a relatively wide range on the position detection sensor, and the painting can favorably be drawn and input, as compared to the electromagnetic resonance pen 1 of the first embodiment.

That is, the inner wall surface of the recessed portion of the front end portion 311 of the core body 310 also faces the side surface of the front end part of the ferrite core 131 and the mount portion 320a of the housing 320 in the case of the electromagnetic resonance pen 3 of the second embodiment. Hence, the electromagnetic resonance pen 3 is not bent even when it is laid down and used. The core body 310 appropriately slides in the axial direction, and the pen pressure can appropriately be applied to the pen pressure detection unit 150.

Moreover, a fitting groove or the like for fitting the part of the core body 310 of the housing 320 does not have to be provided in the case of the electromagnetic resonance pen 3 of the second embodiment described with reference to FIGS. 3A and 3B, and the strength of the housing 320 is not reduced. Further, the front end part of the ferrite core 131 of the coil portion 130 protrudes (is exposed) from the housing 120, and a desirable magnetic field distribution can be formed on the position detection sensor. In addition, even when the front end part of the ferrite core 131 protrudes from the housing 120, the back end portion of the ferrite core 131 is, for example, bonded and fixed to the core holder 140, so that the ferrite core 131 will not be pulled out from the housing 120.

Note that, as illustrated in FIG. 3B, the end portion on the pen tip side of the recessed portion of the front end portion 311 of the core body 310 and the front end part on the pen tip side of the ferrite core 131 have corresponding step shapes such that they are fitted to each other in the electromagnetic resonance pen 3 of the second embodiment. In this way, the end portion on the pen tip side of the recessed portion of the front end portion 311 of the core body 310 and the front end part on the pen tip side of the ferrite core 131 are fitted to each other when the pen pressure is applied to the core body 310, thus preventing rattling in the direction crossing the axial direction.

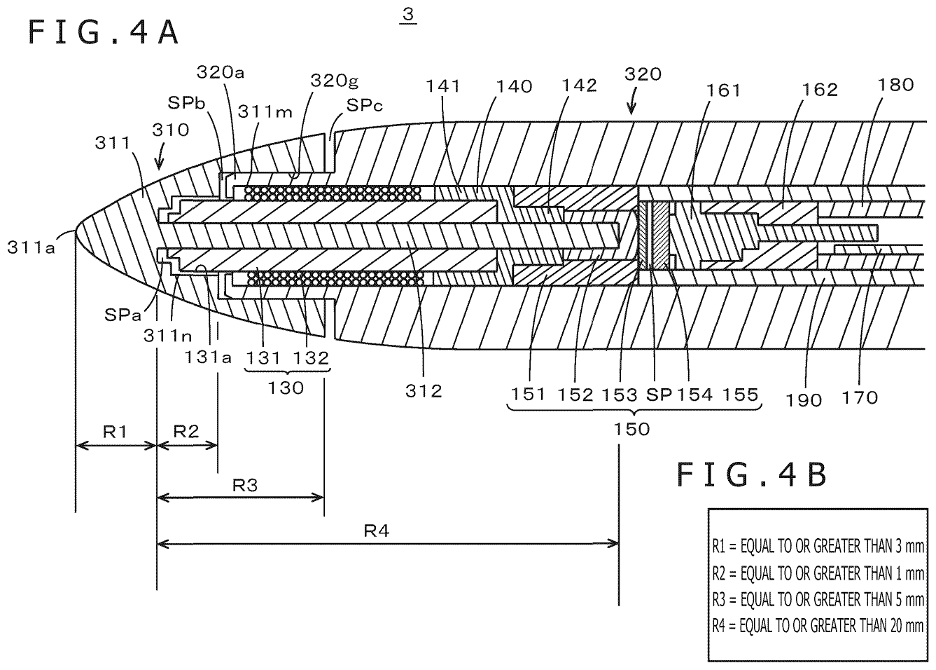

In the electromagnetic resonance pen 3 described with reference to FIGS. 3A and 3B, the positional relation between the ferrite core 131, around which the coil 132 is wound, and the core body 310 is appropriately set, and a desirable magnetic field distribution can be formed on the position detection sensor. FIGS. 4A and 4B are diagrams for describing the sizes of the parts on the pen tip side of the electromagnetic resonance pen 3 of the second embodiment. As illustrated in FIGS. 4A and 4B, the length of the nib portion from the front end 311a to the start point of the core rod 312 (root portion of the core rod 312) of the core body 310 in the axial direction will be referred to as R1. The length of the part where the columnar side surface 131a on the pen tip side of the ferrite core 131 and the first inner wall 311n of the front end portion 311 of the core body 310 face each other will be referred to as R2. The depth of the recessed portion of the front end portion 311 of the core body 310 will be referred to as R3, and the length of the core rod 312 will be referred to as R4.

In this case, the electromagnetic resonance pen 3 that can favorably input writing can be realized by setting the length R1 to be equal to or greater than 3 mm, setting the length R2 to be equal to or greater than 1 mm, setting the depth R3 to be equal to or greater than 5 mm, and setting the length R4 to be equal to or greater than 20 mm as illustrated in FIG. 4B. That is, the electromagnetic resonance pen 3 of the second embodiment can be defined as follows.

It can be stated that the electromagnetic resonance pen 3 of the second embodiment is an electromagnetic resonance pen including
(1) a housing including an opening portion at one end,
(2) a pen pressure detection unit fixed to the housing,
(3) a columnar magnetic body including a through hole around which a coil is wound, and
(4) a core body that transmits force to the pen pressure detection unit, in which the core body includes
(5) a nib portion in which the distance in an axial direction from a front end to a root portion is equal to or greater than 3 millimeters,
(6) a core rod having a length equal to or greater than 20 millimeters in the axial direction from the root portion of the nib portion and passing through the through hole, and
(7) a cover portion covering part of the magnetic body for a distance of equal to or greater than 1 millimeter and covering the core rod from the root portion for a distance of equal to or greater than 5 millimeters in the axial direction.

Note that the cover portion of the core body described in (7) corresponds to the inner wall of the recessed portion of the front end portion 311 in the electromagnetic resonance pen 3 illustrated in FIG. 3B. Specifically, the cover portion of the core body is a part including the first inner wall 311n facing the columnar side surface 131a of the ferrite core 131 and the second inner wall 311m facing the side surface of the mount portion 320a of the housing 320.

Configuration with Added Waterproof Function

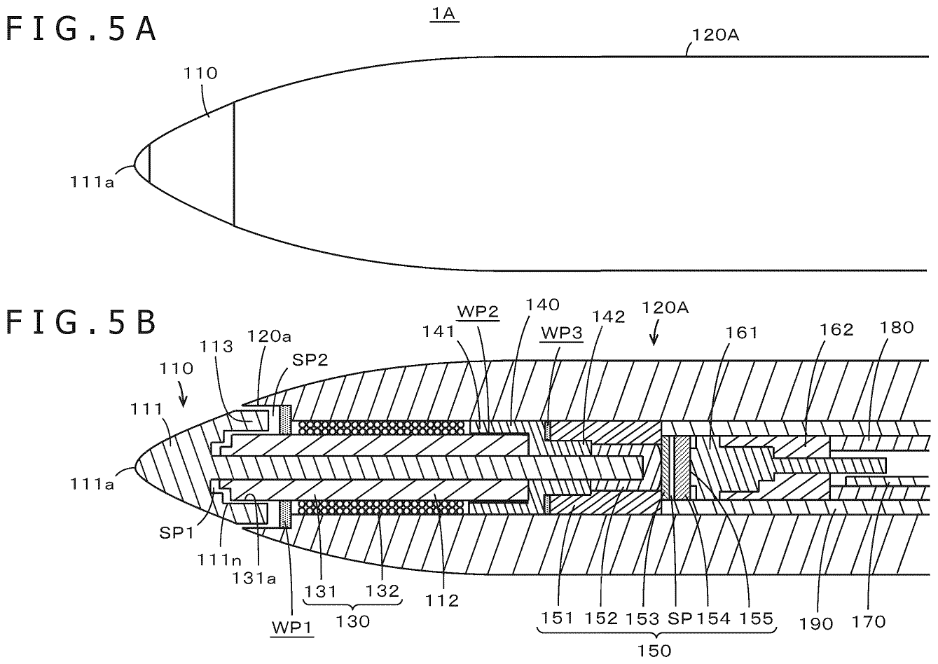

FIGS. 5A and 5B are diagrams for describing a configuration example in which a waterproof function is added to the electromagnetic resonance pen 1 of the first embodiment. As illustrated in FIG. 5A, the appearance of an electromagnetic resonance pen 1A of the example is similar to that of the electromagnetic resonance pen 1 of the first embodiment illustrated in FIG. 2A. However, there is a slight change in a housing 120A, and rubber seals or the like are provided to prevent water from entering.

As can be understood by viewing FIG. 2B, a projection portion projecting toward the inside is formed at the opening part on the pen tip side of the housing 120. Instead of this, a ring-shaped rubber seal WP1 that fills (covers) the part between the inner wall surface of the opening part of the housing 120A and the side surface of the ferrite core 131 is provided at the opening part on the pen tip side of the housing 120A as illustrated in FIG. 5B. This prevents the flow of moisture from the opening part on the pen tip side of the housing 120A to the coil 132 part.

A ring-shaped rubber seal WP2 is further provided between the side surface of the back end part of the ferrite core 131 and the inner wall surface of the holding portion 141 of the core holder 140. This can prevent the flow of moisture entering from the through hole of the ferrite core 131 to the coil 132 side. Note that an adhesive may be used to realize the rubber seal WP2 as an attachment layer. More specifically, the side surface of the back end part of the ferrite core 131 and the inner wall surface of the holding portion 141 of the core holder 140 can be attached by an adhesive to prevent the flow of moisture and also prevent the ferrite core 131 from being pulled out. A rubber seal WP3 is further provided between the core holder 140 and the pen pressure detection unit house 151. This can prevent the flow of moisture to the later stage.

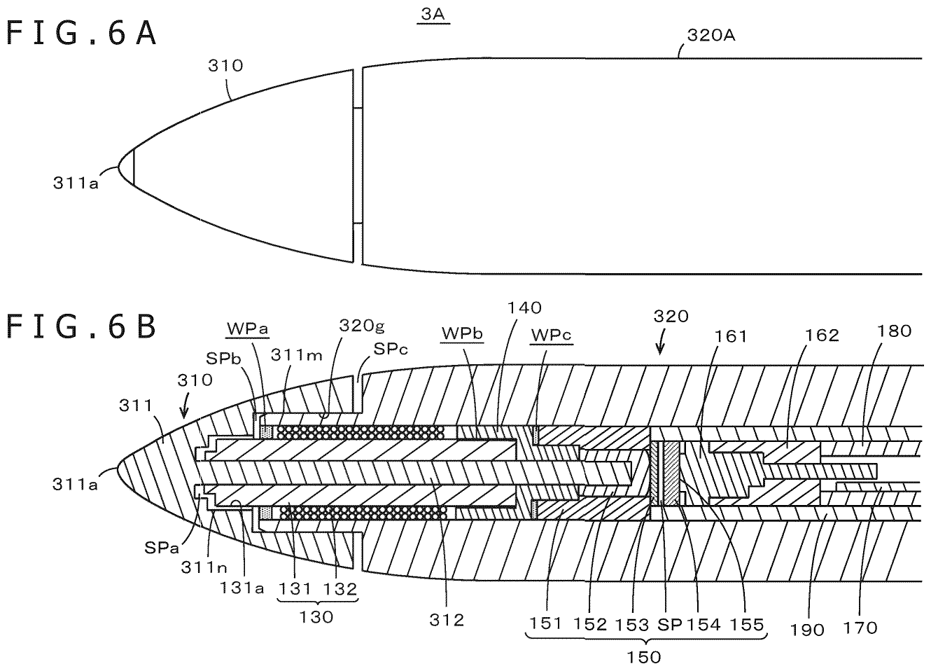

FIGS. 6A and 6B are diagrams for describing a configuration example in which the waterproof function is added to the electromagnetic resonance pen 3 of the second embodiment. As illustrated in FIG. 6A, the appearance of the electromagnetic resonance pen 3A of the example is similar to that of the electromagnetic resonance pen 3 of the second embodiment illustrated in FIG. 3A. However, there is a slight change in a housing 320A, and rubber seals or the like are provided to prevent water from entering.

As can be understood by viewing FIG. 3B, a projection portion projecting toward the inside is formed at the opening part on the pen tip side of the mount portion 320a of the housing 320. Instead of this, a ring-shaped rubber seal WPa that fills (covers) the part between the inner wall surface of the opening part of the mount portion 320a of the housing 320A and the side surface of the ferrite core 131 is provided as illustrated in FIG. 6B. This prevents the flow of moisture from the opening part on the pen tip side of the housing 320A to the coil 132 part.

A ring-shaped rubber seal WPb is further provided between the side surface of the back end part of the ferrite core 131 and the inner wall surface of the holding portion 141 of the core holder 140. This can prevent the flow of moisture entering from the through hole of the ferrite core 131 to the coil 132 side. Note that an adhesive may be used to realize the rubber seal WPb as an attachment layer. More specifically, the side surface of the back end part of the ferrite core 131 and the inner wall surface of the holding portion 141 of the core holder 140 can be attached by an adhesive to prevent the flow of moisture and also prevent the ferrite core 131 from being pulled out. A rubber seal WPc is further provided between the core holder 140 and the pen pressure detection unit house 151. This can prevent the flow of moisture to the later stage.

Note that the rubber seals WP1, WP2, WP3, WPa, WPb, and WPc may contain rubber, resin, or urethane such as PORON (registered trademark). Various attachment materials may be used when the adhesive is used to realize the rubber seals WP2 and WPb as attachment layers as long as the material can attach the ferrite core 131 and the holding portion 141 of the core holder 140, which are basically thin and small, with sufficient strength.

### Advantageous Effects of Embodiments

According to the electromagnetic resonance pens 1 and 3 of the embodiments described above, when the electromagnetic resonance pen is laid down and used for painting, the magnetic field distribution is formed in a relatively wide range on the position detection sensor, and the painting can be drawn and input. Moreover, a fitting groove or the like for fitting the part of the core body 110 to the housing 120 does not have to be provided in the case of the electromagnetic resonance pen 1 of the first embodiment described with reference to FIGS. 2A and 2B, and the strength of the housing 120 is not reduced. An incident that the ferrite core 131 is pulled out can also be prevented, and the waterproof function can also be added.

It is to be noted that the embodiment of the present disclosure is not limited to the foregoing embodiments, and that various changes can be made without departing from the spirit of the present disclosure.

1. An electromagnetic resonance pen comprising:
a housing including an opening portion at one end;
a pen pressure detection unit fixed to the housing;
a columnar magnetic body around which a coil is wound and which includes a through hole; and
a core body including:
a core rod loosely fitted to the through hole and configured to transmit force to the pen pressure detection unit, and
a wall portion including an inner wall facing a columnar side surface of the magnetic body along a predetermined length in an axial direction of the housing,
wherein
the electromagnetic resonance pen uses the magnetic body to form a magnetic field.

2. The electromagnetic resonance pen according to claim 1, wherein
a diameter of an outer wall of the wall portion is smaller than a diameter of the opening portion, and
the wall portion is placed between the magnetic body and the housing along a predetermined length in the axial direction.

3. The electromagnetic resonance pen according to claim 1, wherein
part of the magnetic body is exposed from the opening portion in a state in which the core body is removed.

4. The electromagnetic resonance pen according to claim 3, wherein
the magnetic body is attached to a magnetic body holder, and the magnetic body holder is fixed to the housing.

5. The electromagnetic resonance pen according to claim 4, wherein
the magnetic body holder is formed by a resin material.

6. The electromagnetic resonance pen according to claim 1, further comprising:
a first waterproof member provided between an inner wall near the opening portion of the housing and the columnar side surface of the magnetic body; and
a second waterproof member including a magnetic body holder that holds a back end part of the magnetic body and being provided between a side surface of the back end part of the magnetic body and an inner wall surface of the magnetic body holder.

7. An electromagnetic resonance pen comprising:
a housing including an opening portion at one end;
a core body including a front end portion and a core rod;
a magnetic body which is formed in a columnar shape wherein a coil is wound around the magnetic body, the magnetic body including a hole through which the core rod passes wherein a front end side of the magnetic body is provided at a position exposed from the opening portion in a state in which the core body is removed; and
a magnetic body holder that is fixed to the housing and includes a fixing portion which fixes a back end side of the magnetic body to prevent the magnetic body from being pulled out from the opening portion.

8. The electromagnetic resonance pen according to claim 7, wherein
the magnetic body holder is formed by a resin material.

9. The electromagnetic resonance pen according to claim 7, wherein
the fixing portion is an attachment layer containing an attachment material.

10. The electromagnetic resonance pen according to claim 7, wherein
the front end portion of the core body includes a wall portion including an inner wall facing a side surface of the magnetic body along a predetermined length in an axial direction of the housing.

11. The electromagnetic resonance pen according to claim 10, wherein
a surface of an outer diameter of the opening portion of the housing and a surface of the inner wall of the core body face each other for a length of a second distance in the axial direction.

12. The electromagnetic resonance pen according to claim 7, further comprising:
a first waterproof member provided between an inner wall near the opening portion of the housing and a side surface on the front end side of the magnetic body; and
a second waterproof member provided between a side surface of a back end part of the magnetic body and an inner wall surface of the magnetic body holder.

13. An electromagnetic resonance pen comprising:
a housing including an opening portion at one end;
a pen pressure detection unit fixed to the housing;
a columnar magnetic body around which a coil is wound and which includes a through hole; and
a core body that transmits force to the pen pressure detection unit, wherein
the core body includes
a nib portion in which a distance in an axial direction from a front end to a root portion is equal to or greater than 3 millimeters,
a core rod having a length equal to or greater than 20 millimeters in the axial direction from the root portion of the nib portion and passing through the through hole, and
a cover portion covering part of the magnetic body for a distance of equal to or greater than 1 millimeter and covering the core rod from the root portion for equal to or greater than 5 millimeters in the axial direction.

14. The electromagnetic resonance pen according to claim 13, wherein
the cover portion includes an inner surface in contact with the magnetic body.

15. The electromagnetic resonance pen according to claim 13, wherein
the cover portion includes an inner surface in contact with part of the housing.
